(19) United States
(12) Patent Application Publication
(10) Pub. No.: US 2026/0245849 A1
(43) Pub. Date: Aug. 20, 2026

(54) MASS SPECTROMETRY METHOD AND MASS SPECTROMETRY APPARATUS

(71) Applicant: SHIMADZU CORPORATION, Kyoto-shi (JP)

(72) Inventor: Kosuke UCHIYAMA, Kyoto-shi (JP)

(21) Appl. No.: 19/165,410

(22) PCT Filed: Apr. 24, 2023
(86) PCT No.: PCT/JP2023/016084

§ 371 Date: Sep. 15, 2025

(51) Int. Cl. H01J 49/00; H01J 49/40

(52) U.S. Cl. CPC H01J 49/0036; H01J 49/0081; H01J 49/40

(57) ABSTRACT

One aspect of the mass spectrometry method according to the present invention is a mass spectrometry method using a mass spectrometry apparatus capable of performing MS/MS analysis by DDA, the method comprising: a first measurement step (S1) of performing a survey scan measurement on a sample; a peak selection step (S2) of selecting a peak that meets a predetermined selection condition within a set selectable m/z range in the mass spectrum obtained by the survey scan measurement; a transmission window determination step (S3) of determining a transmission window of a predetermined m/z width that includes the m/z of the selected peak; a second measurement step (S4) of, following the survey scan measurement, performing an MS/MS analysis with ions having an m/z included in the entire m/z range corresponding to the transmission window as precursor ions; and an m/z range setting step (S5-S7) of, after the MS/MS analysis is performed, updating the selectable m/z range so as to exclude the m/z range corresponding to the transmission window from the peak selection target for a predetermined period.

### TECHNICAL FIELD

The present invention relates to a mass spectrometry method and a mass spectrometry apparatus, and more particularly, to a mass spectrometry method using MS/MS analysis and a mass spectrometry apparatus capable of MS/MS analysis.

### BACKGROUND ART

In recent years, tandem mass spectrometry apparatuses capable of MS/MS analysis, such as triple quadrupole mass spectrometers and quadrupole-time-of-flight mass spectrometers, have been widely used for the identification, quantification, or structural analysis of compounds in complex samples containing a wide variety of compounds. In liquid chromatograph-mass spectrometers (LC-MS) and gas chromatograph-mass spectrometers (GC-MS) that use a tandem mass spectrometer as a detector, Data Dependent Acquisition (DDA, or Data Dependent Analysis) is well known as a method for MS/MS analysis in the mass spectrometer (see Patent Documents 1 and 2).

In DDA, first, a mass spectrum is acquired by a normal scan measurement that does not dissociate ions (hereinafter sometimes referred to as a “survey scan”), and based on the signal intensity or the like of a peak observed in that mass spectrum, a peak of a specific mass-to-charge ratio (strictly speaking, denoted in italics as m/z, but referred to as “m/z” or “mass-to-charge ratio” in this specification) is selected. Then, following the survey scan, an MS/MS analysis (product ion scan measurement) is performed with the ion having the m/z value corresponding to the selected peak as a precursor ion, and an MS/MS spectrum in which various productions are observed is acquired.

DDA is also called the shotgun method, and it is desirable to collect information on product ions corresponding to various types of compounds contained in a sample as comprehensively as possible. However, in LC-MS and GC-MS, since the same type of compound is continuously introduced into the mass spectrometer for a certain period of time, if a process that simply selects a peak with a large signal intensity in the mass spectrum is performed, there is a concern that product ion information derived from the same compound will be continuously collected. To avoid this, conventional apparatuses employ a function to exclude the m/z value of a peak, once selected as a precursor ion, from the selection target of precursor ions for a predetermined period.

### CITATION LIST

### Patent Literature

[Patent Document 1] International Publication No. WO 2017/158770

[Patent Document 2] Japanese Unexamined Patent Application Publication No. 2012-2544

### SUMMARY OF INVENTION

### Technical Problem

Furthermore, if only the peak with the same m/z value is excluded from the precursor ion selection target, there is a possibility that an isotopic ion peak derived from the same compound but differing only in isotope elements, and thus having a slightly different m/z value, may be selected again as a precursor ion. Therefore, the apparatus described in Patent Document 2 employs a function to exclude ions included in an entire predetermined m/z value range with respect to the m/z value of an ion peak once selected as a precursor ion from the precursor ion selection target for a predetermined period.

According to the technology described in Patent Document 2, it is possible to avoid the re-selection of isotopic ions with different m/z values derived from the same compound or adduct ions, in which a specific substance such as Na is added to an ion derived from a certain compound, as precursor ions. However, if the m/z value of an ion peak derived from a certain compound is close to the m/z value of an ion peak derived from another compound, a situation may arise where the ion derived from one of the compounds is not selected as a precursor ion, and product ion information corresponding to that compound cannot be obtained. Moreover, for compounds with a large molecular weight, it is common for a considerable number of isotopic ion peaks with slightly different m/z values to appear for a single compound. In such cases, even if the isotopic ion peak with the highest signal intensity is selected as a precursor ion, it may be difficult to ensure the quality (S/N ratio, sensitivity, etc.) of the MS/MS spectrum due to the small ion amount.

The present invention has been made to solve the above problems, and its main object is to provide a mass spectrometry method and a mass spectrometry apparatus that can comprehensively collect product ion information corresponding to a wide variety of compounds contained in a sample.

### Solution to Problem

One aspect of the mass spectrometry method according to the present invention is a mass spectrometry method using a mass spectrometry apparatus capable of performing MS/MS analysis by Data Dependent Acquisition, comprising:
a first measurement step of performing a survey scan measurement on a sample;
a peak selection step of selecting a peak that meets a predetermined selection condition within a set selectable mass-to-charge ratio range in the mass spectrum obtained by the survey scan measurement;
a transmission window determination step of determining a transmission window of a predetermined mass-to-charge ratio width that includes the mass-to-charge ratio of the selected peak;
a second measurement step of, following the survey scan measurement, performing an MS/MS analysis with ions having a mass-to-charge ratio included in the entire mass-to-charge ratio range corresponding to the transmission window as precursor ions; and
a mass-to-charge ratio range setting step of, after the MS/MS analysis is performed, updating the selectable mass-to-charge ratio range so as to exclude the mass-to-charge ratio range corresponding to the transmission window from the peak selection target in the peak selection step for a predetermined period.

Further, one aspect of the mass spectrometry apparatus according to the present invention is a mass spectrometry apparatus capable of performing MS/MS analysis by Data Dependent Acquisition, comprising:
a peak selection unit configured to select a peak that meets a predetermined selection condition within a set selectable mass-to-charge ratio range in a mass spectrum obtained by performing a survey scan measurement on a sample;
a transmission window determination unit configured to determine a transmission window of a predetermined mass-to-charge ratio width that includes the mass-to-charge ratio of the selected peak;
a measurement unit configured to, following a survey scan measurement, perform an MS/MS analysis with ions having a mass-to-charge ratio included in the entire mass-to-charge ratio range corresponding to the transmission window as precursor ions; and
a mass-to-charge ratio range setting unit configured to, after the MS/MS analysis by the measurement unit is performed, update the selectable mass-to-charge ratio range so as to exclude the mass-to-charge ratio range corresponding to the transmission window from the peak selection target in the peak selection unit for a predetermined period.

### Advantageous Effects of Invention

According to the above aspects of the mass spectrometry method and mass spectrometry apparatus of the present invention, after an MS/MS spectrum with an ion derived from a certain compound as a precursor ion is acquired, the ion peak and isotopic ion peaks derived from that compound are not selected as precursor ions for a predetermined period. This can prevent the product ion information of the same compound from being acquired repeatedly in succession. On the other hand, since an MS/MS spectrum is obtained using all ions corresponding to the entire transmission window of a predetermined mass-to-charge ratio width, including the selected ion peak, as precursor ions, even when the m/z values of ions derived from a plurality of different compounds are close, product ion information for both of those compounds can be collected without omission. This can improve the comprehensiveness of the collection of product ion information corresponding to a wide variety of compounds contained in a sample.

### BRIEF DESCRIPTION OF DRAWINGS

FIG. 1 is a schematic configuration diagram of a Q-TOFMS according to an embodiment of the present invention.

FIG. 2 is a flowchart showing the execution procedure of analysis in DDA mode in the Q-TOFMS of this embodiment.

FIG. 3 is an explanatory diagram of the processing in the analysis in DDA mode in the Q-TOFMS of this embodiment.

### DESCRIPTION OF EMBODIMENTS

Since the mass spectrometry apparatus according to the present invention only needs to be capable of MS/MS analysis, it can include, for example, a triple quadrupole mass spectrometer, a quadrupole-time-of-flight mass spectrometer (hereinafter referred to as “Q-TOFMS”), an ion trap-time-of-flight mass spectrometer, an ion trap mass spectrometer, and the like.

Hereinafter, a Q-TOFMS, which is an embodiment of the mass spectrometry apparatus according to the present invention, will be described with reference to the accompanying drawings.

### Configuration of Q-TOFMS

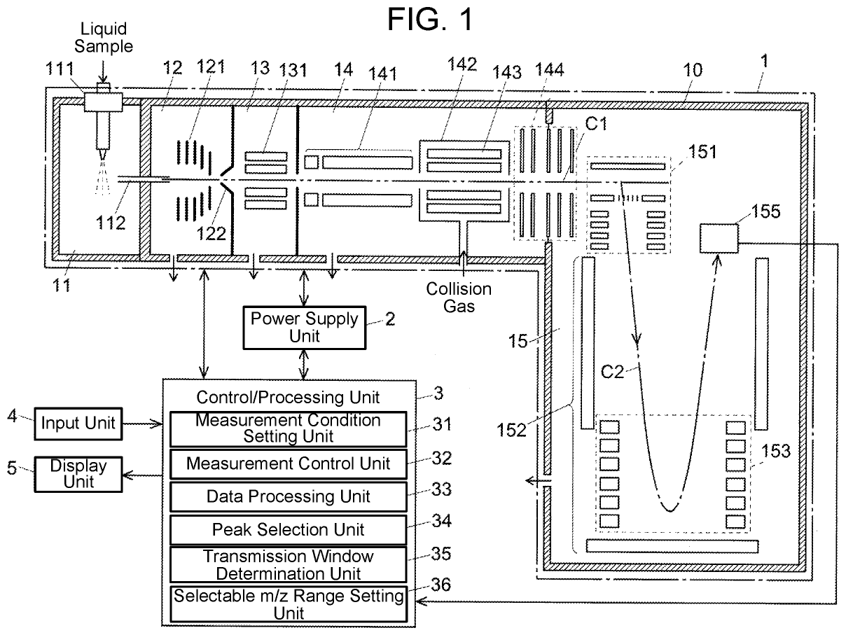

FIG. 1 is a schematic configuration diagram of the Q-TOFMS of this embodiment.

This Q-TOFMS is a mass spectrometry apparatus that is connected to, for example, a liquid chromatograph (LC) (not shown) to constitute an LC-MS, and comprises a measurement unit 1, a power supply unit 2, a control/processing unit 3, an input unit 4, and a display unit 5. The measurement unit 1 includes an ionization chamber 11, which is in a substantially atmospheric pressure atmosphere, and a vacuum chamber 10, the interior of which is divided into four sections. Inside the vacuum chamber 10, a first intermediate vacuum chamber 12, a second intermediate vacuum chamber 13, a first high vacuum chamber 14, and a second high vacuum chamber 15 are provided, and each chamber is evacuated by a vacuum pump (not shown) so that the degree of vacuum increases in this order.

In the ionization chamber 11, an electrospray ionization (ESI) probe 111 to which a liquid sample is supplied is disposed, and the ionization chamber 11 and the first intermediate vacuum chamber 12 communicate through a thin desolvation tube 112. The first intermediate vacuum chamber 12 and the second intermediate vacuum chamber 13 communicate through an orifice formed at the top of a skimmer 122, and ion guides 121 and 131 are disposed in the first intermediate vacuum chamber 12 and the second intermediate vacuum chamber 13, respectively. In the first high vacuum chamber 14, a quadrupole mass filter 141 and a collision cell 142, in which an ion guide 143 is disposed, are provided along an ion optical axis C1. Further, a plurality of electrodes arranged to span the first high vacuum chamber 14 and the second high vacuum chamber 15 constitute an ion guide 144. Furthermore, in the second high vacuum chamber 15, an orthogonal acceleration type time-of-flight mass separator, which comprises an orthogonal acceleration unit 151 and an ion flight section 152 including a reflectron 153, and an ion detector 155 are provided.

The power supply unit 2 drives the measurement unit 1 by applying predetermined voltages to the electrodes and the like included in the measurement unit 1, under the control of the control/processing unit 3. The control/processing unit 3 is responsible for controlling the operation of the measurement unit 1 and processing the data obtained by the measurement unit 1, and includes, as functional blocks, a measurement condition setting unit 31, a measurement control unit 32, a data processing unit 33, a peak selection unit 34, a transmission window determination unit 35, and a selectable m/z range setting unit 36.

In general, the actual entity of the control/processing unit 3 is a computer such as a personal computer or a workstation, and the above functional blocks are embodied by executing one or more dedicated software programs (computer programs) installed on such a computer. Such a computer program can be provided to the user stored in a computer-readable non-transitory recording medium such as a CD-ROM, a DVD-ROM, a memory card, or a USB memory (dongle). Alternatively, it can be provided to the user in the form of data transfer via a communication line such as the Internet. Alternatively, it can be pre-installed on a computer that is part of the system at the time the user purchases the system.

### Schematic Measurement Operation of Q-TOFMS

The measurement control unit 32 controls the power supply unit 2 and controls the various voltages applied to the measurement unit 1, thereby causing the measurement unit 1 to perform analysis on the liquid sample that is sequentially supplied over time. When an LC is connected upstream of the Q-TOFMS, a liquid sample containing various components separated by the column of the LC is supplied to the ESI probe 111. A typical measurement operation performed under the control of the measurement control unit 32 will be schematically described.

In this Q-TOFMS, it is possible to selectively perform normal mass spectrometry (MS analysis) without ion dissociation and MS/MS analysis that dissociates ions by Collision-Induced Dissociation (CID).

The ESI probe 111 sprays the supplied liquid sample into the ionization chamber 11 as charged droplets. The charged droplets come into contact with the surrounding residual gas and become finer, and in the process of the solvent in the droplets vaporizing, the compounds in the droplets become gas-phase ions. The generated ions are sent into the first intermediate vacuum chamber 12 via the desolvation tube 112, and are introduced into the quadrupole mass filter 141 in the first high vacuum chamber 14 via the ion guide 121, the skimmer 122, and the ion guide 131 in order. In the case of MS analysis, the ions substantially pass through the quadrupole mass filter 141 and the collision cell 142 and are transported to the orthogonal acceleration unit 151 via the ion guide 144.

On the other hand, in the case of MS/MS analysis, predetermined voltages are applied to each of a plurality of rod electrodes constituting the quadrupole mass filter 141, and ions having a specific m/z or having an m/z included in a specific m/z range according to the voltages selectively pass through the quadrupole mass filter 141 as precursor ions. A collision gas such as Ar gas is introduced into the collision cell 142, and the precursor ions come into contact with the collision gas and are dissociated by CID, generating various product ions. The generated product ions are transported to the orthogonal acceleration unit 151 via the ion guide 144.

The numerous ions that have reached the orthogonal acceleration unit 151 are accelerated substantially all at once in a direction substantially orthogonal to their incident direction. The accelerated ions fly in a folded path in the ion flight section 152, as indicated by the chain-dotted line C2 in FIG. 1, at a speed corresponding to their respective m/z, and reach the ion detector 155. The various ions that started from the orthogonal acceleration unit 151 at substantially the same time reach and are detected by the ion detector 155 in order of increasing m/z, and the ion detector 155 outputs detection data (ion intensity data) corresponding to the number of ions to the control/processing unit 3. In the control/processing unit 3, the data processing unit 33 creates a time-of-flight spectrum based on the received data, and further creates an MS spectrum or an MS/MS spectrum by converting the time of flight into m/z.

Note that, in many cases, the S/N ratio and sensitivity of the data obtained in one cycle of ion injection from the orthogonal acceleration unit 151→ion flight in the ion flight section 152→ion detection by the ion detector 155 are not sufficiently high. Therefore, generally, a mass spectrum or an MS/MS spectrum is created by continuously repeating the measurement cycle corresponding to the same m/z range multiple times and integrating the data obtained in each of the multiple cycles.

### Description of Characteristic DDA Mode Operation

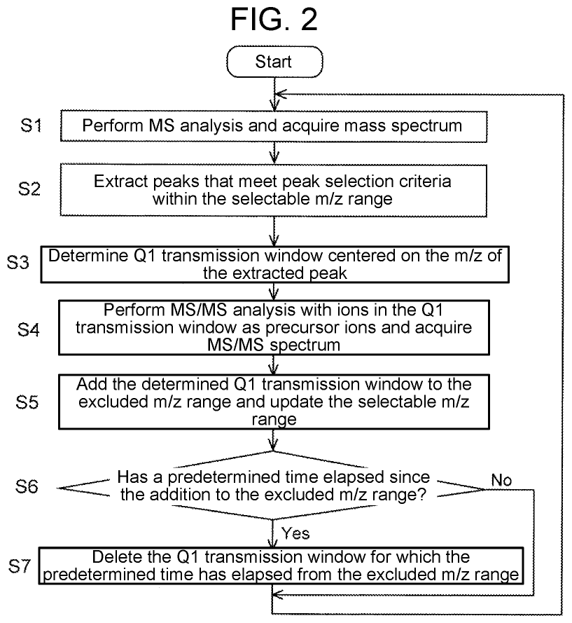

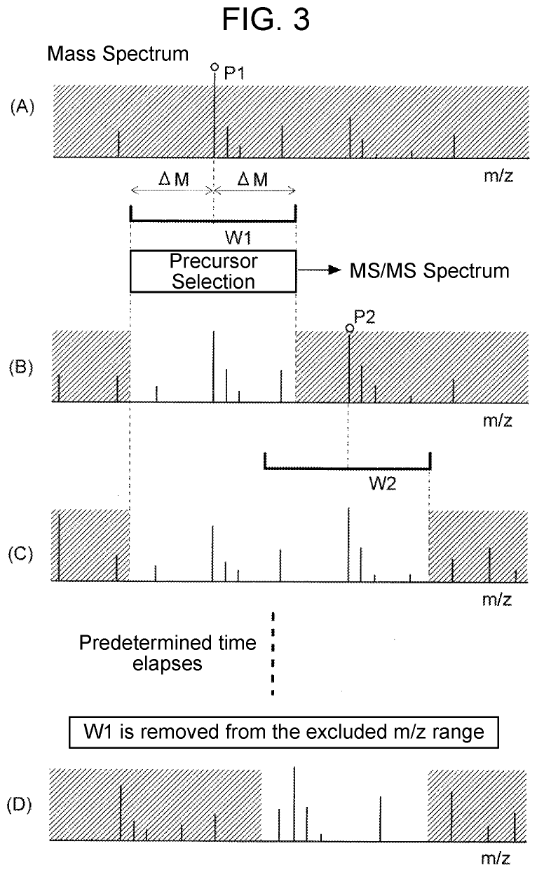

Next, the characteristic DDA mode analysis operation performed in this Q-TOFMS will be described. FIG. 2 is a flowchart of the execution procedure of this operation, and FIG. 3 is an explanatory diagram of this operation.

Prior to analysis, the user operates the input unit 4 to input the measurement conditions for the DDA mode, or changes the predetermined default values as necessary. The measurement condition setting unit 31 accepts operations such as inputting and changing measurement conditions and saves the measurement conditions. The measurement conditions include peak selection conditions and conditions for determining a Q1 transmission window, which will be described later.

The peak selection conditions are conditions for extracting one or more peaks in the mass spectrum, and can include, for example, the order of selection, such as in descending order of signal intensity, or in descending order of signal intensity within a predetermined range, and the number of peaks to select. In addition, conditions for preferential selection or exclusion during peak selection can also be set. For example, for a compound that is important even if its signal intensity is low, the m/z value corresponding to that compound can be designated as a peak to be preferentially selected. Also, for example, if it is desired to exclude compounds contained in the solvent or the mobile phase of the LC from the measurement target, the m/z values corresponding to such compounds can be designated as peaks to be excluded from selection. These are merely examples, and the peak selection conditions, including preferentially selected peaks and peaks excluded from selection, may be determined as appropriate. On the other hand, the conditions for determining the Q1 transmission window are the m/z width of the Q1 transmission window (here, the upper and lower width with respect to the center m/z value) and the valid period (time) for excluding one Q1 transmission window.

When measurement is started, the measurement unit 1, under the control of the measurement control unit 32, executes MS analysis over a predetermined m/z range, that is, a survey scan measurement. Note that although it is not actually a scan measurement because a TOFMS is used here, it will be referred to as a survey scan measurement for convenience of explanation. The data processing unit 33 receives signal intensity data from the survey scan measurement from the measurement unit 1 and creates a mass spectrum over the predetermined m/z range (Step S1).

When the mass spectrum is created, the peak selection unit 34 detects peaks in the mass spectrum within the selectable m/z range set by the selectable m/z range setting unit 36, and extracts peaks that meet the preset peak selection conditions from among the detected peaks (Step S2). The “selectable m/z range” is the m/z range excluding the excluded m/z range described later, but at the start of measurement, there is no excluded m/z range. Therefore, the selectable m/z range setting unit 36 sets the entire m/z range (actually, the m/z range of the mass spectrum) as the selectable m/z range.

Here, as a simple example, let the peak selection condition be to select one peak in descending order of signal intensity. For example, if the mass spectrum shown in FIG. 3(A) is currently obtained, the peak P1 with the maximum signal intensity is selected in Step S2.

Although not shown in FIG. 2, if no peak that meets the peak selection conditions exists in Step S2, there is no precursor ion for which MS/MS analysis should be performed, so the processing of Steps S3 to S7 is skipped, the process returns to Step S1, and waits until the next MS analysis is performed.

When a peak is extracted in Step S2, the transmission window determination unit 35 determines a Q1 transmission window having a predetermined m/z window width centered on the m/z value of the extracted peak (Step S3). For example, as shown in FIG. 3(A), if the m/z value of the peak P1 is M1 and the m/z width is ±ΔM, the m/z range of the Q1 transmission window W1 is M1−ΔM to M1+ΔM. For example, if the m/z window width is set to ±2 [u] and M1 is m/z 500, the m/z range of the Q1 transmission window is 498 to 502.

Here, since it is meaningless for the m/z window width to be smaller than the m/z resolution of the survey scan measurement, it is at least the width corresponding to the m/z resolution of the survey scan measurement. Specifically, the m/z window width is usually in the range of about ±0.8 to ±10 [u], and can be determined as appropriate by the user.

Note that in the apparatus of this embodiment, the user can set the m/z window width to be vertically symmetrical, such as to u, with respect to the center m/z value. For example, in the apparatus described in Patent Document 2 mentioned as a prior art, it is necessary to independently specify the m/z range to be automatically excluded from precursor selection in the lower (smaller m/z value) direction and the upper (larger m/z value) direction with respect to the m/z value of the precursor ion. This is because, in a quadrupole mass filter, even if one attempts to pass ions with a width above and below a certain m/z value as the center, the m/z width with respect to that m/z value is not equal in the upper and lower directions, and for that reason, the m/z range is usually set so that the m/z width on the upper side of the precursor ion's m/z is wider. However, it is difficult for a user to understand such circumstances and determine an appropriate m/z width. In contrast, the apparatus of this embodiment has a function that, even if the vertical m/z width with respect to the center m/z value is set to be the same on the user interface, an automatic adjustment is made so that the upper m/z width becomes wider, centered on the m/z value of the selected peak. This has the advantage of simplifying the operation, as it eliminates the need for the user to perform complicated settings based on specialized knowledge.

Subsequently, the measurement control unit 32 receives the information of the determined Q1 transmission window and, through the power supply unit 2, controls the measurement unit 1 to perform MS/MS analysis with the ions whose m/z are included in the entire m/z range of the determined Q1 transmission window collectively as precursor ions. For example, when the Q1 transmission window is m/z 498 to m/z 502 as described above, the quadrupole mass filter 141 in the measurement unit 1 is driven so that all ions having an m/z value in the range of m/z 498 to m/z 502 pass through. Then, ions having various m/z values included in this m/z range are dissociated by CID in the collision cell 142, and the various product ions generated by this dissociation are separated and detected in the orthogonal acceleration type time-of-flight mass analyzer. That is, if a peak that meets the peak selection conditions is found in Step S2, MS/MS analysis is performed following the survey scan measurement. The data processing unit 33 receives the detection data obtained by the MS/MS analysis from the measurement unit 1 and creates an MS/MS spectrum (Step S4).

As can be seen from FIG. 3(A), there are usually multiple types of ions with different m/z values within the Q1 transmission window. These ions may be isotopic ions for the same compound, or they may be ions derived from completely different compounds. The MS/MS spectrum obtained in Step S4 can include information on various product ions generated by dissociating these multiple types of ions.

Note that in the example shown in FIG. 2, only one MS/MS analysis is performed following the survey scan measurement, but if time permits, multiple MS/MS analyses for different precursor ions can be performed following the survey scan measurement.

Next, the selectable m/z range setting unit 36 adds the m/z range of the Q1 transmission window determined in Step S3 to the excluded m/z range and updates the selectable m/z range (Step S5). For example, if the Q1 transmission window W1 is determined as shown in FIG. 3(A), the selectable m/z range is updated from the range shown by hatching in FIG. 3(A) to the range shown by hatching in FIG. 3(B).

After that, the selectable m/z range setting unit 36 determines whether a predetermined time has elapsed since the time when the excluded m/z range was added (Step S6). This determination is performed not only for the excluded m/z range added in the immediately preceding Step S5, but for all excluded m/z ranges that have been added since the start of measurement and have not yet been deleted at that point (that is, are valid as excluded m/z ranges). As described above, the predetermined time for this determination can also be set or changed by the user. It is desirable that this predetermined time be determined in consideration of the spread (peak width) of the chromatographic peak for one compound assumed in the LC. Generally, this predetermined time is from a few seconds to several tens of seconds, but it can be several minutes depending on the separation conditions and the like.

If there is a Q1 transmission window for which the predetermined time has elapsed since the time of addition to the excluded m/z range, the selectable m/z range setting unit 36 deletes that Q1 transmission window from the excluded m/z range (Step S7) and returns to Step S1. When the process returns to Step S1, a survey scan measurement is performed again, and a process of extracting a peak that meets the peak selection conditions is performed on the mass spectrum created as a result of that measurement.

However, at this time, unlike the first survey scan measurement, a Q1 transmission window has been added to the excluded m/z range, so the selectable m/z range is limited. For example, in the example of FIG. 3(B), since the m/z range corresponding to the Q1 transmission window W1 is excluded from the selectable m/z range, even if a peak that meets the peak selection conditions exists in this m/z range of M1−ΔM to M1+ΔM, that peak is not selected. In this example of FIG. 3(B), the peak P2 existing in the selectable m/z range shown by hatching is selected as one that meets the peak selection conditions.

In Step S3, a new Q1 transmission window W2 is determined for this selected peak P2, and in the subsequent Step S4, MS/MS analysis is performed with the ions having m/z values included in the entire m/z range corresponding to that Q1 transmission window W2 collectively as precursor ions. Then, in Step S5, this Q1 transmission window W2 is newly added to the m/z exclusion range, so the selectable m/z range is further limited, as shown by the hatching in FIG. 3(C).

In this way, the selection of a peak in the mass spectrum obtained by the survey scan measurement and the MS/MS analysis with ions of a wide range of m/z values corresponding to the Q1 transmission window including the selected peak as precursor ions are repeated. Then, when a predetermined time elapses after a single Q1 transmission window is added to the excluded m/z range, that Q1 transmission window is deleted from the excluded m/z range by the processing of Steps S6 and S7, thereby expanding the selectable m/z range, as shown in FIG. 3(D).

As described above, in the Q-TOFMS of this embodiment, it is possible to avoid the re-selection as precursor ions of not only the m/z value of the ion peak selected based on signal intensity or the like, but also ions such as isotopic ions having m/z values close to that m/z value. On the other hand, even when an ion derived from a certain compound and an ion derived from a completely different compound have close m/z values and their retention times are close, product ion information for both compounds can be reliably collected, preventing the omission of product ion information for one of the compounds. In addition, it is possible to acquire product ion information with a plurality of isotopic ion peaks with slightly different m/z values, derived from a single compound, collectively as precursor ions. Therefore, even in cases where the signal intensity is dispersed over many isotopic ion peaks on the mass spectrum, it is possible to obtain an MS/MS spectrum with good sensitivity.

The peak selection method and the method for determining the m/z value of the precursor ion based on the selected peak described in the above embodiment can be combined with conventionally known or used techniques as long as they do not contradict them.

For example, a method is known in which an m/z value to be excluded from precursor ions (and its tolerance) and an exclusion time range are set in advance, and ions of the set m/z value are excluded over the set time range, and the above method can be used in combination with this. Also, for example, even within an excluded m/z range, it is possible not to exclude an m/z value (and its tolerance) that has been predetermined to be preferentially selected as a precursor ion.

Furthermore, although the operation in DDA mode was repeated in the description of the above embodiment, there are also cases where Data Independent Acquisition (DIA), which is another data acquisition method, and DDA are performed alternately, or where DDA is performed once for every multiple DIAs. It is clear that the method according to the present invention is also effective in such cases.

Furthermore, although the above embodiment applies the mass spectrometry apparatus according to the present invention to a Q-TOFMS, as described above, the present invention can be generally applied to other types of mass spectrometry apparatuses capable of MS/MS analysis, such as a triple quadrupole mass spectrometer, an ion trap-time-of-flight mass spectrometer, and an ion trap mass spectrometer. It is also clear that the ionization method in the ion source is not limited to ESI, and appropriate ionization methods such as APCI, PESI, and DART can be used.

Furthermore, the above embodiment is merely an example of the present invention, and it is clear that appropriate modifications, changes, and additions made within the spirit of the present invention are included in the scope of the claims of this application.

### VARIOUS ASPECTS

It is clear to those skilled in the art that the exemplary embodiments described above are specific examples of the following aspects.

(Aspect 1) One aspect of the mass spectrometry method according to the present invention is a mass spectrometry method using a mass spectrometry apparatus capable of performing MS/MS analysis by Data Dependent Acquisition, comprising:
a first measurement step of performing a survey scan measurement on a sample;
a peak selection step of selecting a peak that meets a predetermined selection condition within a set selectable mass-to-charge ratio range in the mass spectrum obtained by the survey scan measurement;
a transmission window determination step of determining a transmission window of a predetermined mass-to-charge ratio width that includes the mass-to-charge ratio of the selected peak;
a second measurement step of, following the survey scan measurement, performing an MS/MS analysis with ions having a mass-to-charge ratio included in the entire mass-to-charge ratio range corresponding to the transmission window as precursor ions; and
a mass-to-charge ratio range setting step of, after the MS/MS analysis is performed, updating the selectable mass-to-charge ratio range so as to exclude the mass-to-charge ratio range corresponding to the transmission window from the peak selection target in the peak selection step for a predetermined period.

(Aspect 4) One aspect of the mass spectrometry apparatus according to the present invention is a mass spectrometry apparatus capable of performing MS/MS analysis by Data Dependent Acquisition, comprising:
a peak selection unit configured to select a peak that meets a predetermined selection condition within a set selectable mass-to-charge ratio range in a mass spectrum obtained by performing a survey scan measurement on a sample;
a transmission window determination unit configured to determine a transmission window of a predetermined mass-to-charge ratio width that includes the mass-to-charge ratio of the selected peak;
a measurement unit configured to, following a survey scan measurement, perform an MS/MS analysis with ions having a mass-to-charge ratio included in the entire mass-to-charge ratio range corresponding to the transmission window as precursor ions; and
a mass-to-charge ratio range setting unit configured to, after the MS/MS analysis by the measurement unit is performed, update the selectable mass-to-charge ratio range so as to exclude the mass-to-charge ratio range corresponding to the transmission window from the peak selection target in the peak selection unit for a predetermined period.

According to the mass spectrometry method described in Aspect 1 and the mass spectrometry apparatus described in Aspect 4, after an MS/MS spectrum with an ion derived from a certain compound as a precursor ion is acquired, the ion peak and isotopic ion peaks derived from that compound are not selected as precursor ions for a predetermined period. This can prevent the product ion information of the same compound from being acquired repeatedly in succession. On the other hand, since an MS/MS spectrum is obtained using all ions corresponding to the entire transmission window of a predetermined mass-to-charge ratio width, including the selected ion peak, as precursor ions, even when the m/z values of ions derived from a plurality of different compounds are close, product ion information for both of those compounds can be collected without omission. This can improve the comprehensiveness of the collection of product ion information corresponding to a wide variety of compounds contained in a sample.

(Aspect 2) In the mass spectrometry method according to Aspect 1, the mass-to-charge ratio width of the transmission window can be set to be wider than the mass-to-charge ratio width corresponding to the mass resolution in the survey scan measurement.

(Aspect 5) Further, in the mass spectrometry apparatus according to Aspect 4, the mass-to-charge ratio width of the transmission window can be set to be wider than the mass-to-charge ratio width corresponding to the mass resolution in the survey scan measurement.

According to the mass spectrometry method described in Aspect 2 and the mass spectrometry apparatus described in Aspect 5, ion peaks derived from different compounds that have m/z values close to each other but with an m/z difference greater than the mass resolution can fit within the transmission window. This allows for the reliable collection of product ion information for these multiple compounds.

(Aspect 3) In the mass spectrometry method according to Aspect 1 or 2, in the peak selection step, a plurality of peaks can be selected for one mass spectrum, in the transmission window determination step, a transmission window is determined for each of the plurality of peaks selected in the peak selection step, and in the second measurement step, MS/MS analysis is performed for different precursor ions corresponding to each of the plurality of determined transmission windows.

(Aspect 6) In the mass spectrometry apparatus according to Aspect 4 or 5, the peak selection unit allows the selection of a plurality of peaks for one mass spectrum, the transmission window determination unit determines a transmission window for each of the plurality of peaks selected by the peak selection unit, and the measurement unit performs MS/MS analysis for different precursor ions corresponding to each of the plurality of determined transmission windows.

According to the mass spectrometry method described in Aspect 3 and the mass spectrometry apparatus described in Aspect 6, product ion information derived from a plurality of compounds can be collected for one survey scan measurement. This improves the efficiency of product ion information collection and can reduce the occurrence of missed collection of product ion information even when a large number of compounds are included in the sample.

(Aspect 7) The mass spectrometry apparatus according to any one of Aspects 4 to 6 can further comprise an input receiving unit that determines the predetermined mass-to-charge ratio width in the transmission window determination unit and/or the predetermined period in the mass-to-charge ratio range setting unit in response to user input.

According to the mass spectrometry apparatus described in Aspect 7, the user can appropriately set the mass-to-charge ratio width of the transmission window and the time for which the same transmission window is continuously excluded from peak selection, according to the purpose of the analysis, the type of sample, the analysis conditions, and so on. This enables more accurate collection of product ion information as desired by the user.

(Aspect 8) The mass spectrometry apparatus according to any one of Aspects 4 to 7 can be a quadrupole-time-of-flight mass spectrometer.

According to the mass spectrometry apparatus described in Aspect 8, since peak selection can be performed based on a high-quality mass spectrum obtained with high mass resolution, an ion peak that reliably meets the peak selection conditions can be selected.

This makes it easier to obtain product ion information of a compound that better suits the purpose.

### REFERENCE SIGNS LIST

1 . . . Measurement Unit
10 . . . Vacuum Chamber
11 . . . Ionization Chamber
12 . . . First Intermediate Vacuum Chamber
13 . . . Second Intermediate Vacuum Chamber
14 . . . First High Vacuum Chamber
15 . . . Second High Vacuum Chamber
111 . . . ESI Probe
112 . . . Desolvation Tube
121, 131, 143, 144 . . . Ion Guide
122 . . . Skimmer
141 . . . Quadrupole Mass Filter
142 . . . Collision Cell
151 . . . Orthogonal Acceleration Unit
152 . . . Ion Flight Section
153 . . . Reflectron
155 . . . Ion Detector
2 . . . Power Supply Unit
3 . . . Control/Processing Unit
31 . . . Measurement Condition Setting Unit
32 . . . Measurement Control Unit
33 . . . Data Processing Unit
34 . . . Peak Selection Unit
35 . . . Transmission Window Determination Unit
36 . . . Selectable m/z Range Setting Unit
4 . . . Input Unit
5 . . . Display Unit

1. A mass spectrometry method using a mass spectrometry apparatus capable of performing MS/MS analysis by Data Dependent Acquisition, the method comprising:
a first measurement step of performing a survey scan measurement on a sample;
a peak selection step of selecting a peak that meets a predetermined selection condition within a set selectable mass-to-charge ratio range in the mass spectrum obtained by the survey scan measurement;
a transmission window determination step of determining a transmission window of a predetermined mass-to-charge ratio width that includes the mass-to-charge ratio of the selected peak;
a second measurement step of, following the survey scan measurement, performing an MS/MS analysis with ions having a mass-to-charge ratio included in the entire mass-to-charge ratio range corresponding to the transmission window as precursor ions; and
a mass-to-charge ratio range setting step of, after the MS/MS analysis is performed, updating the selectable mass-to-charge ratio range so as to exclude the mass-to-charge ratio range corresponding to the transmission window from the peak selection target in the peak selection step for a predetermined period.

2. The mass spectrometry method according to claim 1, wherein the mass-to-charge ratio width of the transmission window is set to be wider than the mass-to-charge ratio width corresponding to the mass resolution in the survey scan measurement.

3. The mass spectrometry method according to claim 1, wherein in the peak selection step, a plurality of peaks can be selected for one mass spectrum, in the transmission window determination step, a transmission window is determined for each of the plurality of peaks selected in the peak selection step, and in the second measurement step, MS/MS analysis is performed for different precursor ions corresponding to each of the plurality of determined transmission windows.

4. A mass spectrometry apparatus capable of performing MS/MS analysis by Data Dependent Acquisition, the apparatus comprising:
a peak selection unit configured to select a peak that meets a predetermined selection condition within a set selectable mass-to-charge ratio range in a mass spectrum obtained by performing a survey scan measurement on a sample;
a transmission window determination unit configured to determine a transmission window of a predetermined mass-to-charge ratio width that includes the mass-to-charge ratio of the selected peak;
a measurement unit configured to, following a survey scan measurement, perform an MS/MS analysis with ions having a mass-to-charge ratio included in the entire mass-to-charge ratio range corresponding to the transmission window as precursor ions; and
a mass-to-charge ratio range setting unit configured to, after the MS/MS analysis by the measurement unit is performed, update the selectable mass-to-charge ratio range so as to exclude the mass-to-charge ratio range corresponding to the transmission window from the peak selection target in the peak selection unit for a predetermined period.

5. The mass spectrometry apparatus according to claim 4, wherein the mass-to-charge ratio width of the transmission window is set to be wider than the mass-to-charge ratio width corresponding to the mass resolution in the survey scan measurement.

6. The mass spectrometry apparatus according to claim 4, wherein
the peak selection unit allows the selection of a plurality of peaks for one mass spectrum, the transmission window determination unit determines a transmission window for each of the plurality of peaks selected by the peak selection unit, and
the measurement unit performs MS/MS analysis for different precursor ions corresponding to each of the plurality of determined transmission windows.

7. The mass spectrometry apparatus according to claim 4, further comprising an input receiving unit configured to determine the predetermined mass-to-charge ratio width in the transmission window determination unit and/or the predetermined period in the mass-to-charge ratio range setting unit in response to user input.

8. The mass spectrometry apparatus according to claim 4, which is a quadrupole-time-of-flight mass spectrometer.
